(19) United States
(12) Patent Application Publication
(10) Pub. No.: US 2010/0159094 A1
(43) Pub. Date: Jun. 24, 2010

(54) Process for the Preparation of Ready to Cook Food Products

(76) Inventor: Ghanshyam Das Agrawal, Calcutta (IN)

Correspondence Address: THE WEBB LAW FIRM, P.C., 700 KOPPERS BUILDING, 436 SEVENTH AVENUE, PITTSBURGH, PA, 15219, US

(21) Appl. No.: 12/340,015

(22) Filed: Dec. 19, 2008

(51) Int. Cl. A23L 3/44; A23C 1/06; A23C 19/10

(52) U.S. Cl. 426/327; 426/618; 426/438; 426/384; 426/582

(57) ABSTRACT

A process for preparation of KOFTA comprising steps of boiling potato and vegetables etc, mixing with binder such as gram flour and salt, spices, condiments etc to obtain a mixture subjected to freeze drying and/or vacuum frying. A process for preparation of lentil/cereal/vegetables preparation comprising steps of soaking, boiling, freeze drying and vacuum frying. A method of preparing snack comprising steps of partially cooking the snack followed by vacuum frying. Further, this invention is directed to paneer preparation comprising of paneer, vegetable, spices and flavourings. A KOFTA preparation comprising of KOFTA, vegetable, spices and flavourings. A curry masala preparation comprising of vegetable, spices and flavourings. The ingredients are freeze dried and/or vacuum fried wherever required.

### FIELD OF INVENTION

This invention relates to a process for preparation of KOFTA, lentil/cereal/vegetables preparations and preparations such as pakorras, samosas etc, and PANEER food preparations, KOFTA food preparations and curry masala preparations. This invention particularly relates to a process for preparation of ready to cook Instant cooking Indian KOFTA, an economical energy conserving process for preparation of ready to cook Indian lentil/cereal/vegetables preparations, a method for preparing long shelf life preparations such as pakorras, sarmosas etc, a ready to cook instant cooking Indian PANEER (COTTAGE CHEESE) food preparations, a ready to cook instant cooking Indian KOFTA (vegetable &/or cheese balls in curry) food preparations and a ready to cook instant cooking Indian curry masala preparations.

### BACKGROUND OF INVENTION

Ready to eat food preparations are known in the art. However, ready to cook food preparations comprising of KOFTA, ready to cook food preparations containing Indian lentil/cereal/vegetables, ready to cook Indian food preparations and ready to cook Indian curry masala preparations are not known in the art.

Hither to, preparation comprising Indian snacks such as samosas and pakorras were eaten immediately. Thus, ready to cook snacks were not hitherto known.

### OBJECTS OF INVENTION

An object of this invention is to propose a process for preparation of ready to cook Instant cooking Indian KOFTA.

Another object of this invention is to propose a process for preparation of a ready to cook Instant cooking Indian KOFTA which after preparation has the flavour and texture as that of a normally cooked preparation.

Still another object of this invention is to propose a process for preparation of ready to cook Instant cooking Indian KOFTA which is convenient to prepare.

An object of this invention is to propose an economical energy conserving process for preparation of ready to cook Indian lentil/cereal/vegetables preparations.

Another object of this invention is to propose a process for preparation of a ready to cook Indian lentil/cereal/vegetables preparation which after preparation has the flavor and texture as that of a normally cooked preparation.

Still another object of this invention is to propose a process for preparation of ready to cook Indian lentil/cereal/vegetables preparations which is convenient to prepare.

Still another object of this invention is to propose a process for preparation of ready to cook Indian lentil/cereal/vegetables preparations which is economical and energy conserving.

An object of this invention is to propose a long shelf life food snack.

Another object of this invention is to propose a long shelf life food snack which has crispy qualities similar to that of freshly cooked snack.

An object of this invention is to propose a ready to cook instant cooking Indian PANEER (COTTAGE CHEESE) food preparations.

Another object of this invention is to propose a ready to cook instant cooking Indian PANEER (COTTAGE CHEESE) food preparations, which has after cooking, the same flavor & texture as an originally cooked food.

An object of this invention is to propose a ready to cook instant cooking Indian KOFTA (vegetable &/or cheese balls in curry) food preparations.

Another object of this invention is to propose a ready to cook instant cooking Indian KOFTA food preparations, which has after cooking, the same flavor & texture as an originally cooked food.

An object of this invention is to propose a ready to cook instant cooking Indian curry masala preparations.

Another object of this invention is to propose a ready to cook instant cooking Indian curry masala preparations, which has after cooking, the same flavor & texture as an originally cooked food.

Further objects and advantages of this invention will be more apparent from the ensuing description.

### SUMMARY OF THE INVENTION

According to this invention there is provided a process for preparation of a ready to cook Instant cooking Indian KOFTA comprising steps of:—Cleaning, cutting and boiling potato & vegetables etc; Mixing with binder such as wheat flour/pea, gram flour, Mixing with salt, spices condiments, flavoring agents, preservatives etc so as to obtain a mixture, Preparing balls using said mixture. Freezing, Freeze drying &/or vacuum frying.

Further, according to this invention there is provided an economical energy conserving process for preparation of a ready to cook Indian lentil/cereal/vegetables preparation comprising steps of:—
soaking the Indian lentil/cereal/vegetables;
boiling the Indian lentil/cereal/vegetables;
subjecting the Indian lentil/cereal/vegetables to the step of freezing,
freeze drying and
vacuum frying

Further, according to this invention there is provided a method of preparing a long shelf life snack comprising steps of: partially cooking the snack and vacuum frying the snack so as to reduce the moisture content.

Further, according to this invention there is provided a ready to cook instant cooking Indian PANEER (COTTAGE CHEESE) preparation comprising of:
a. 50 to 90% by wt. of PANDER (COTTAGE CHEESE),
b. 10 to 40% by wt. of Indian vegetable, spices such as onion, tomato, garlic & ginger,
C. 5 to 30% by wt. of flavorings.

Further, according to this invention there is provided a ready to cook instant cooking Indian KOFTA preparations comprising of:
a. 50 to 90% by wt. of KOFTA,
b. 10 to 40% by wt. of Indian vegetable, spices such as onion, tomato, garlic & ginger,
C. 5 to 30% by wt. of flavorings.

Further, according to this invention there is provided a ready to cook instant cooking Indian curry masala preparation comprising of:
a. 40 to 80% by wt. of Indian vegetable, spices such as onion, tomato, garlic & ginger,
b. 20 to 60% by wt. of flavorings.

### DETAIL DESCRIPTION OF THE INVENTION

This invention provides a process for preparation of ready to cook Instant cooking Indian KOFTA comprising of the following steps:—
1) Cleaning, cutting and boiling potato & vegetables etc;
2) Mixing with binder such as wheat flour/pea, gram flour;
3) Optionally mixing with milk products such as cottage cheese/milk powder, curd etc;
4) Mixing with salt, spices & condiments etc;
5) Preparing balls of the mixture thus obtained;
6) Freezing up to −20° C. (minus twenty degree Celsius);
7) Freeze drying &/or vacuum frying

The invention provides a process for preparation of a ready to cook Instant cooking Indian KOFTA in which potato &/or vegetables are cleaned, cut & boiled. This is followed by mixing with binder such as wheat/gram flour. Thereafter, milk products such as cottage cheese &/or milk powder may optionally be added. There is still another option, which requires addition of dry fruit/dry fruit powder. Then, spices, salts, &/or flavors &/or preservatives &/or emulsifiers & condiments are added so as to obtain a mixture.

This mix is converted into small balls, which are frozen to −20 degree centigrade. After freezing these are freeze dried &/or vacuum fried. Freeze drying is conducted at for example under vacuum of 0.1-10 torr for 1-8 hours preferably for 2 hours.

The vacuum frying is carried out in oil at for example 70-120° C. preferably at 100° C. under vacuum of 1-20 Torr for 5-60 minutes preferably for 15-40 minutes.

Further, this invention provides a process for preparation of ready to cook Indian lentil/cereal/vegetables preparation comprising the following steps:—
1) soaking the lentil/cereal/vegetables;
2) boiling the lentil/cereal/vegetables;
3) subjecting the lentil/cereal/vegetables to the step of freezing;
4) freeze drying
5) Vacuum frying.

The invention provides a process for preparation of a ready to cook Indian lentil/cereal/vegetables preparation in which the lentil/cereal/vegetables such as chick pea/ladies finger is subjected to soaking/cleaning in water at temperature such as 29-35° C. for such as 5 min to 10 hrs. This is followed by partial cooking/boiling such as for 20-30 minutes and draining the water and subsequently cooling off. Thereafter, the boiled lentil/cereal/vegetables is subjected to freezing for example up to −20° C. (minus twenty).

The frozen lentil/cereal/vegetables thus obtained is subjected to freeze drying at for example under vacuum of 0.1-10 torr for 30 min-4 hours preferably for 2 hours. Thereafter, frying in oil is done at for example 70-120° C. preferably at 100° C. under vacuum of 1-100 Torr. The frying is carried out for 5-60 minutes preferably for 15 minutes.

In the present invention, there is provided a combination of freeze drying and vacuum frying which conserves energy. Combination processing is faster and cost effective than any of the processes alone.

This invention also provides a method of preparing a long shelf life snack. This method comprises partially cooking the snack by deep frying the snack at 120-150° C. for 5-20 minutes. This is followed by vacuum frying the snack such that the moisture content is reduced to 3-5%. The vacuum frying comprising the step of freezing for example up to −20° C.

This is followed by freeze drying under vacuum of for example 1-10 Torr and/or vacuum frying in oil under vacuum of 10-100 torr at a temperature of 70-120° C.

By following above said steps, most of moisture is taken out of food. Lack of water preserves the food in proper packaging. This can be cooked instantly upon requirement with hardly any change in taste and texture.

Again, this invention provides a ready to cook instant cooking Indian PANDER (COTTAGE CHEESE) preparations comprising of the following:

50 to 90% by wt. of freeze dried &/or vacuum fried PANEER (COTTAGE CHEESE); 10 to 40% by wt. of freeze dried &/or vacuum fried or otherwise dried vegetable, spices such as onion, tomato, garlic & ginger, 5 to 30% by wt. of flavorings such as condiments, spices, salt, preservatives, added flavors, emulsifiers, thickeners, potato powder, powdered dry fruits, milk products and other such ingredients.

In accordance with this invention the food preparation comprises 50 to 90% by wt. of PANEER (COTTAGE CHEESE), which are freeze dried &/or vacuum fried.

10 to 40% by wt. of freeze dried &/or vacuum fried vegetable, spices such as onion, tomato, garlic & ginger.

5 to 30% by wt. of flavorings such as condiments, spices, salt, preservatives, added flavors, emulsifiers, thickeners, potato powder, milk products, powdered dry fruits and other such ingredients.

Further, this invention provides a ready to cook instant cooking Indian KOPTA (vegetable &/or cheese balls in curry) preparations comprising of the following:

50 to 90% by wt. of freeze dried &/or vacuum fried KOFTA (made of vegetables/potato/cottage cheese and some cereal powders); 10 to 40% by wt. of freeze dried &/or vacuum fried vegetable, spices such as onion, tomato, garlic & ginger and 5 to 30% by wt. of flavorings such as condiments, spices, salt, preservatives, added flavors, emulsifiers, thickeners, potato powder, powdered dry fruits, milk products and other such ingredients.

In accordance with this invention the food preparation comprises 50 to 90% by wt. of KOFTA, which are freeze dried &/or vacuum fried.

10 to 40% by wt. of freeze dried &/or vacuum fried vegetable, spices such as onion, tomato, garlic & ginger.

5 to 30% by wt. of flavorings such as condiments, spices, salt, preservatives, added flavors, emulsifiers, thickeners, potato powder, milk products, powdered dry fruits and other such ingredients.

Further, this invention provides a ready to cook instant cooking Indian curry masala preparation comprising of the following:
1. 40 to 80% by wt. of freeze dried &/or vacuum fried vegetable, spices such as onion, tomato, garlic & ginger.
2. 20 to 60% by wt. of flavorings such as condiments, spices, salt, preservatives, added flavors, emulsifiers, thickeners, potato powder, milk products, dry fruit powder and other such ingredients.

It is to be noted that the present invention is susceptible to modifications, adaptations and changes by those skilled in the art. Such variant embodiments employing the concepts and features of this invention are intended to be within the scope of the present invention, which is further set forth under the following claims:—

1-25. (canceled)

26. A process for the preparation of a ready to cook instant cooking Indian KOFTA comprising the steps of:
1) cleaning, cutting and boiling potatoes and vegetables;
2) mixing the potatoes and vegetables with a binder;
3) adding at least one of salt, spices, condiments, flavoring agents, and preservatives to obtain a mixture;
4) preparing balls from said mixture;
5) freezing said balls; and
6) freeze drying and/or vacuum frying said balls.

27. The process as claimed in claim 26, wherein said mixing with the binder is followed by mixing with at least one milk product selected from the group consisting of cottage cheese, milk powder, and curd.

28. The process as claimed in claim 26, including the addition of dry fruits and/or dry fruit powder after the step of mixing the potatoes and vegetables with a binder.

29. The process as claimed in claim 26, wherein the KOFTA (balls) are frozen at a temperature of up to −20° C.

30. The process as claimed in claim 26, wherein the freeze drying is carried out under a vacuum of approximately 0.1-10 torr for about 60-480 minutes.

31. The process as claimed in claim 26, wherein the vacuum frying is carried out in oil at approximately 70-120° C. under vacuum of approximately 1-20 torr for about 5-60 minutes.

32. An economical energy conserving process for preparation of a ready to cook Indian lentil/cereal/vegetable preparation comprising the steps of:
1) soaking the lentil/cereal/vegetables;
2) boiling the lentil/cereal/vegetables;
3) subjecting the lentil/cereal/vegetables to the step of freezing; and
4) freeze drying and/or vacuum frying the lentil/cereal/vegetables.

33. The process as claimed in claim 32, wherein the soaking is carried out in water at a temperature of approximately 29-35° C. for about 5-10 hours.

34. The process as claimed in claim 32, wherein the boiling is conducted for about 20-30 minutes.

35. The process as claimed in claim 32, wherein the boiled lentil/cereal/vegetables is subjected to freezing at a temperature of up to −20° C.

36. The process as claimed in claim 32, wherein the freeze drying is carried out at approximately 1-10 torr for about 4 to 8 hours.

37. The process as claimed in claim 32, wherein the vacuum frying is carried out in oil at approximately 70-120° C. under vacuum of approximately 1-100 torr for about 5-60 minutes.

38. A method of preparing a long shelf-life snack comprising the steps of:
a) partially cooking the snack and
b) vacuum frying the snack so as to reduce the moisture content.

39. The method as claimed in claim 38, wherein said partial cooking comprises deep frying the snack at approximately 120-150° C. for about 5-20 minutes.

40. The method as claimed in claim 38, including the step of freeze-drying the snack, wherein said freeze-drying comprises the step of freezing the snack at a temperature of up to −20° C.

41. The method as claimed in claim 40, wherein said step of freezing is followed by freeze drying under vacuum of approximately 1-10 torr and/or vacuum frying in oil under vacuum of approximately 10-100 torr at a temperature of approximately 70-120° C.

42. A ready to cook instant cooking Indian PANEER (COTTAGE CHEESE) preparation comprising:
a. 50 to 90% by weight of PANEER (COTTAGE CHEESE);
b. 10 to 40% by weight of vegetables and spices; and
c. 5 to 30% by weight of flavorings.

43. A ready to cook instant cooking Indian PANEER (COTTAGE CHEESE) preparation as claimed in claim 42, wherein the PANEER (COTTAGE CHEESE) is freeze dried and/or vacuum fired.

44. A ready to cook instant cooking Indian PANEER (COTTAGE CHEESE) preparation as claimed in claim 42, wherein the vegetables and spices are freeze dried and/or vacuum fried.

45. A ready to cook instant cooking Indian KOFTA preparation comprising:
a. 50 to 90% by weight of KOFTA;
b. 10 to 40% by weight of vegetables and spices; and
c. 5 to 30% by weight of flavorings.

46. A ready to cook instant cooking Indian KOFTA preparation as claimed in claim 45, wherein the KOFTA is freeze dried and/or vacuum fried.

47. A ready to cook instant cooking Indian KOFTA preparation as claimed in claim 45, wherein the vegetables and spices are freeze dried and/or vacuum fried.

48. A ready to cook instant cooking Indian curry masala preparation comprising:
a. 40 to 80% by weight of vegetables and spices; and
b. 20 to 60% by weight of flavorings.

49. A ready to cook instant cooking Indian curry masala preparation as claimed in claim 48, wherein the vegetables and spices are freeze dried and/or vacuum fried.

50. A ready to cook instant cooking Indian curry masala as claimed in claim 48, wherein said flavorings are selected from the group consisting of condiments, spices, salt, preservatives, added flavors, emulsifiers, thickeners, potato powder, milk products, and dry fruit powder.
